(19) United States
(12) Patent Application Publication
(10) Pub. No.: US 2012/0264955 A1
(43) Pub. Date: Oct. 18, 2012

(54) SYSTEMS AND METHODS FOR PRODUCING SURFACTANTS AND SURFACTANT INTERMEDIATES

(75) Inventors: Clayton V. McNeff, Andover, MN (US); Daniel Thomas Nowlan, Hugo, MN (US); Larry C. McNeff, Anoka, MN (US); Peter G. Greuel, Anoka, MN (US); Bingwen Yan, Shoreview, MN (US)

(73) Assignee: SARTEC CORPORATION, Anoka, MN (US)

(21) Appl. No.: 13/446,756

(22) Filed: Apr. 13, 2012

Related U.S. Application Data
(60) Provisional application No. 61/474,796, filed on Apr. 13, 2011.

(51) Int. Cl. C11C 3/00

(52) U.S. Cl. 554/92; 554/172; 554/97

(57) ABSTRACT

Embodiments of the invention include processing lipid feedstocks into various products. Embodiments of the invention include processing lipid feedstocks into various products. In an embodiment, the invention includes a method of processing a lipid feedstock comprising combining triglycerides from the lipid feedstock with water to form a first reaction mixture, contacting the first reaction mixture with a first metal oxide catalyst at a temperature of greater than 200 degrees Celsius to form a first product mixture including free fatty acids and glycerin, combining the free fatty acids with a diol to form a second reaction mixture, and contacting the second reaction mixture with a second metal oxide catalyst at a temperature of greater than 200 degrees Celsius to form a second product mixture. Other embodiments are also included herein.

This application claims the benefit of U.S. Provisional Application No. 61/474,796, filed Apr. 13, 2011, the content of which is herein incorporated by reference in its entirety.

### FIELD OF THE INVENTION

The present invention relates to processing lipid feedstocks. More specifically, the present invention relates to methods of making compounds from lipid feedstocks including, but not limited to, esters, ethers, and surfactants.

### BACKGROUND OF THE INVENTION

Lipid feedstocks can be useful in the production of various compounds of industrial significance. Lipid feedstocks can include those containing triglycerides along with varying amounts of fatty acids. Depending on the specific nature of the material from which the lipid feedstock is derived, the fatty acid chains (free and/or as part of triglyceride molecules) may have certain characteristic lengths and structure. For example, coconut oil contains a substantial amount of C12 lauric acid.

Surfactants are compounds that lower the surface tension of a liquid, the interfacial tension between two liquids, or that between a liquid and a solid. Surfactants have many uses and can act as detergents, wetting agents, emulsifiers, foaming agents, and dispersants.

### SUMMARY OF THE INVENTION

Embodiments of the invention include processing lipid feedstocks into various products. In an embodiment, the invention includes a method of processing a lipid feedstock comprising combining triglycerides from the lipid feedstock with water to form a first reaction mixture, contacting the first reaction mixture with a first metal oxide catalyst at a temperature of greater than 200 degrees Celsius to form a first product mixture including free fatty acids and glycerin, combining the free fatty acids with a diol to form a second reaction mixture, and contacting the second reaction mixture with a second metal oxide catalyst at a temperature of greater than 200 degrees Celsius to form a second product mixture.

In an embodiment, the invention includes a method of processing fatty acids comprising combining free fatty acids with a diol to form a reaction mixture; and contacting the reaction mixture with a metal oxide catalyst at a temperature of greater than 250 degrees Celsius to form a product mixture.

In an embodiment, the invention includes a method of making a compound of the formula:

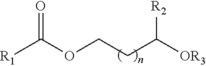

wherein R₁ is CH₃(CH₂)ₘ and may be interrupted with at least one heteroatom selected from the group consisting of amine, ether, ester, amide, sulfur, sulfur monoxide, sulfer dioxide, sulfamate, hydroxy, or mixtures thereof; and m=6-16, n=0 or 1, R₂═H or CH₃; and R₃═H, SO₃X, CO(CH)₂COOH, or COCH(SO₃X)CH₂COOX₁; wherein X and X₁ are the same or different, and each is selected from NH₄^{′}, an alkali metal, an H atom.

In an embodiment the invention includes a method of making a surfactant comprising combining triglycerides from the lipid feedstock with water to form a first reaction mixture; contacting the first reaction mixture with a first metal oxide catalyst at a temperature of greater than 200 degrees Celsius to form a first product mixture including free fatty acids and glycerin; combining the free fatty acids with a diol to form a second reaction mixture; contacting the second reaction mixture with a second metal oxide catalyst at a temperature of greater than 200 degrees Celsius to form a second product mixture; and reacting a constituent of the second product mixture to form a sulfate or a sulfo-succinate compound.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE FIGURES

The invention may be more completely understood in connection with the following drawings, in which:

FIG. 1 is a schematic view of reactor system according to an embodiment.

FIG. 2 is an ¹H-NMR of 3-dodecanoyl-1-propanol produced in accordance with embodiments here.

FIG. 3 is an ¹H-NMR of maleate derived from the reaction of 3-dodecanoyl-1-propanol with maleic anhydride in accordance with embodiments herein.

FIG. 4 is ¹H-NMR of the sulfosuccinate formed from the reaction of 3-dodecanoyl-1-propanol with maleic anhydride followed by reaction with NaHSO₃ in accordance with embodiments herein.

FIG. 5 is ¹H-NMR of the product mixture formed from the reaction of cuphea free fatty acids with propylene glycol in accordance with embodiments herein.

FIG. 6 is ¹H-NMR of the product mixture formed from the reaction of cuphea free fatty acids with ethylene glycol in accordance with embodiments herein.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

The embodiments of the present invention described herein are not intended to be exhaustive or to limit the invention to the precise forms disclosed in the following detailed description. Rather, the embodiments are chosen and described so that others skilled in the art can appreciate and understand the principles and practices of the present invention.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

Embodiments of the invention include methods of making esters, ethers, and various other compounds using esters and/or ethers as reaction intermediates including, but not limited to, surfactants, detergents, wetting agents, emulsifiers, foaming agents, dispersants, and the like. Feedstocks used in accordance with embodiments herein can include natural lipid feedstocks including triglycerides and/or fatty acids. Specific examples of feedstocks are described below. It will be appreciated that compounds produced in accordance with embodiments herein have many industrial applications including but not limited to pharmaceutical compositions, cosmetics compositions, food compositions, general industrial compositions, and printing compositions, and the like.

In some embodiments, a lipid feedstock including a mixture of triglycerides and fatty acids can be subjected to transesterification, esterification, and/or etherification as catalyzed by a metal oxide catalyst. However, in other embodiments, a hydrolysis step can be performed first in order to generate free fatty acids from the triglyceride content of the starting lipid feedstock. It will be appreciated that hydrolysis can be carried out in many ways. However, in a particular embodiment, hydrolysis is carried out as catalyzed by a metal oxide catalyst (MOₓ). The fatty acids can then be separated out from other reaction products such as glycerin.

In various embodiments, esterification and/or etherification can be carried out on the fatty acids with an alcohol as a co-reactant and being catalyzed by a metal oxide catalyst. In some embodiments, the alcohol includes two or more alcohol groups. In some embodiments, the alcohol is a diol. By using a diol, at least some of the reaction products include terminal alcohol groups that can then be utilized in further reaction steps. Various alcohols can be used. In some embodiments, the alcohol can include from one to twenty carbon atoms. In some embodiments, 1,3-propanediol can be used. The following reaction diagram schematically illustrates esterification using a diol:

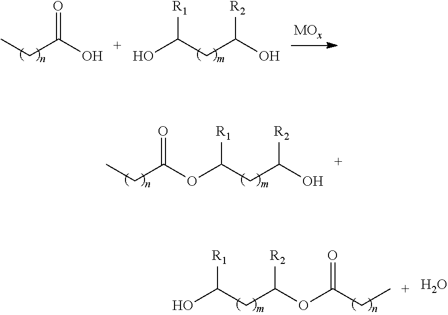

wherein R₁═H or CH₃; R₂═CH₃ or H; n=4-22; and m=0-10.

Similarly, the following reaction diagram schematically illustrates etherification using a diol:

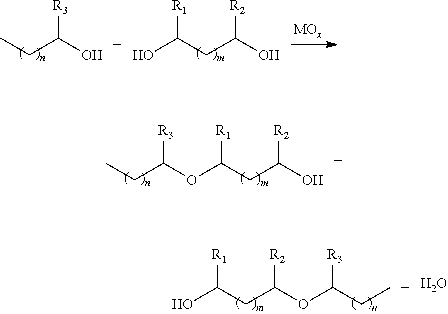

wherein R₁═H or CH₃; R₂═CH₃ or H; R₃═H or CH₃; n=4-22; and m=0-10.

In some embodiments, after obtaining an ester or an ether reaction product including a terminal alcohol group further steps can be performed in order to convert the ester and/or ether into a compound such as a surfactant or the like. By way of example, esters can be turned into sulfosuccinate derivatives. The following reaction diagram schematically illustrates conversion of an ester into a sulfosuccinate derivative.

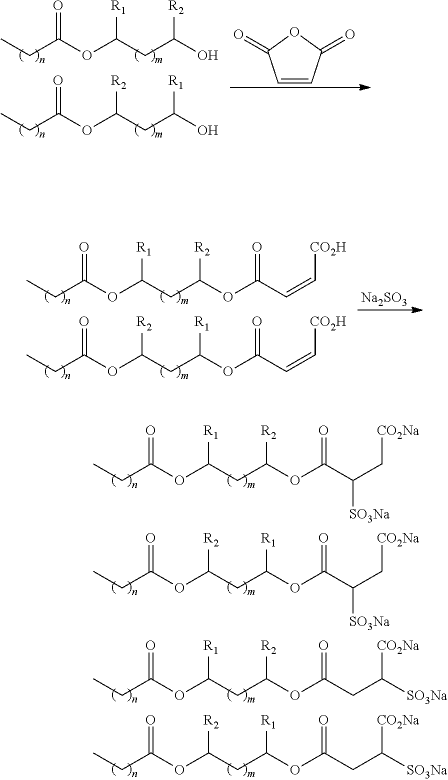

wherein R₁═H or CH₃; R₂═CH₃ or H; n=4-22; and m=0-10.

Similarly, the following reaction diagram schematically illustrates conversion of an ether into an ether sulfosuccinate derivative.

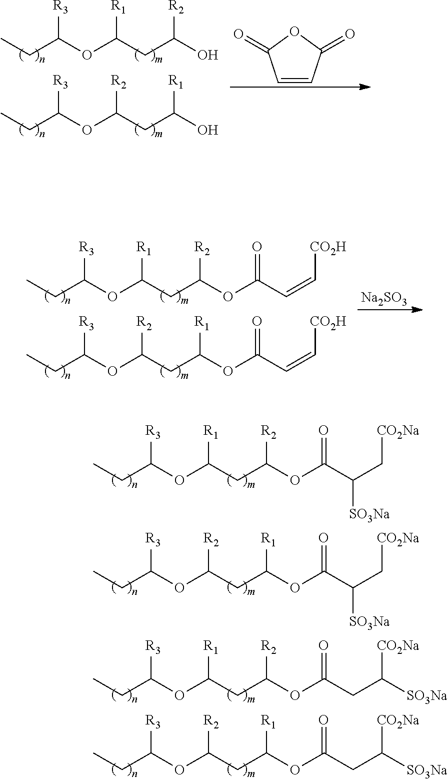

wherein R₁═H or CH₃; R₂═CH₃ or H; R₃═H or CH₃; n=4-22; and m=0-10.

It will be appreciated that ethers and/or esters can be turned into various surfactants in accordance with embodiments herein. By way of example, the following structures represent various groups of surfactant molecules that can be made according to embodiments herein.

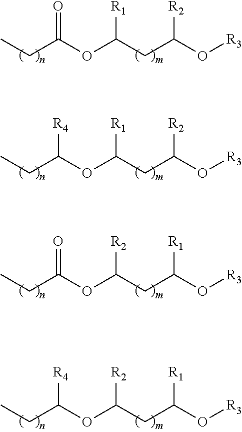

wherein R₁═H or CH₃; R₂═CH₃ or H; R₃═SO₃⁻, PO₃²⁻, NO₃⁻, CH₂CH₂SO₃⁻; n =4-22; and m=0-10.

It will be appreciated that in some embodiments the invention can include a method of making a compound of the formula:

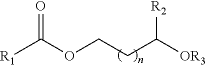

wherein R₁ is CH₃(CH₂)ₘ and may be interrupted with at least one heteroatom selected from the group consisting of amine, ether, ester, amide, sulfur, sulfur monoxide, sulfur dioxide, sulfamate, hydroxy, or mixtures thereof; and m=6-16, n=0 or 1, R₂═H or CH₃; and R₃═H, SO₃X, CO(CH)₂COOH, or COCH(SO₃X)CH₂COOX₁; wherein X and X₁ are the same or different, and each is selected from NH₄⁺, an alkali metal, an H atom. In various embodiments the method can include hydrolyzing triglycerides to form a mixture including free fatty acids; separating out the free fatty acids; reacting the free fatty acids with a compound having at least two alcohol groups to form an ester having a terminal alcohol group. In some embodiments the method can also include reacting the ester having a terminal alcohol group further to form a sulfate or a sulfosuccinate.

In an embodiment, R₁ of the preceding formula may be branched, alkyl, or alkenyl. If R₁ is alkenyl, it preferably comprises no more than one double bond. In some embodiments “m” may be C₆ to C₂₄. In some embodiments, “m” may be C₈ to C₁₄. In some embodiments, “m” may be from C₁₀ to C₁₂.

In an embodiment, the surfactant has a structure according to following formula:

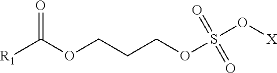

wherein R₁ is C₈-C₁₈ alkyl; and X is selected from NH₄⁺, an alkali metal, or an H atom.

In an embodiment, the surfactant is a sodium lauryl propanediol ester sulfate having the formula:

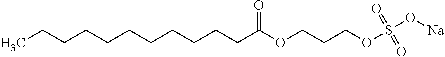

In yet another embodiment, the surfactant has a structure according to the following formula:

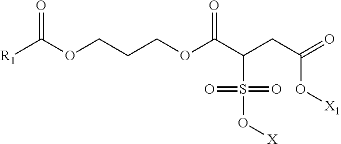

wherein R₁ is C₈-C₁₈ alkyl; and X and X₁ are the same or different, and each is selected from NH₄⁺, an alkali metal, or an H atom.

In a particular embodiment, the surfactant is a disodium propanediol lauryl sulfosuccinate according to the formula:

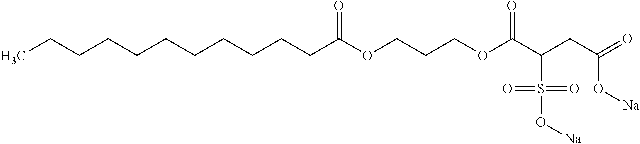

Metal oxide catalysts used with embodiments of the invention can include metal oxides with surfaces including Lewis acid sites, Bronsted base sites, and Bronsted acid sites. By definition, a Lewis acid is an electron pair acceptor. A Bronsted base is a proton acceptor and a Bronsted acid is a proton donor. Metal oxide catalysts of the invention can specifically include zirconia, alumina, titania and hafnia. In some embodiments, the catalyst can consist essentially of such metal oxides. In some embodiments, metal oxide catalysts of the invention can include zirconia, alumina, titania, hafnia, zinc oxide, copper oxide, magnesium oxide and iron oxide. Metal oxide catalysts of the invention can also include silica clad with a metal oxide selected from the group consisting of zirconia, alumina, titania, hafnia, zinc oxide, copper oxide, magnesium oxide and iron oxide.

In some embodiments, the metal oxide catalyst can be of a single metal oxide type. By way of example, in some embodiments, the metal oxide catalyst is substantially pure titania. In some embodiments, the metal oxide catalyst is substantially pure alumina. Metal oxide catalysts of the invention can also include mixtures of metal oxides, such as mixtures of metal oxides including zirconia, alumina, titania and/or hafnia. Of the various metal oxides that can be used with embodiments of the invention, zirconia, titania, alumina and hafnia are advantageous as they are very chemically and thermally stable and can withstand very high temperatures and pressures as well as extremes in pH. Titania and alumina are advantageous because of the additional reason that they are less expensive materials.

Metal oxides of the invention can include metal oxide particles clad with carbon. Carbon clad metal oxide particles can be made using various techniques such as the procedures described in U.S. Pat. Nos. 5,108,597; 5,254,262; 5,346,619; 5,271,833; and 5,182,016, the contents of which are herein incorporated by reference. Carbon cladding on metal oxide particles can render the surface of the particles more hydrophobic.

Metal oxides of the invention can also include polymer coated metal oxides. By way of example, metal oxides of the invention can include a metal oxide coated with polybutadiene (PBD). Polymer coated metal oxide particles can be made using various techniques such as the procedure described in Example 1 of U.S. Pub. Pat. App. No. 2005/0118409, the contents of which are herein incorporated by reference. Polymer coatings on metal oxide particles can render the surface of the particles more hydrophobic.

Metal oxide catalysts of the invention can be made in various ways. As one example, a colloidal dispersion of zirconium dioxide can be spray dried to produce aggregated zirconium dioxide particles. Colloidal dispersions of zirconium dioxide are commercially available from Nyacol Nano Technologies, Inc., Ashland, Mass. The average diameter of particles produced using a spray drying technique can be varied by changing the spray drying conditions. Examples of spray drying techniques are described in U.S. Pat. No. 4,138,336 and U.S. Pat. No. 5,108,597, the contents of both of which are herein incorporated by reference. It will be appreciated that other methods can also be used to create metal oxide particles. One example is an oil emulsion technique as described in Robichaud et al., Technical Note, “An Improved Oil Emulsion Synthesis Method for Large, Porous Zirconia Particles for Packed- or Fluidized-Bed Protein Chromatography,” Sep. Sci. Technol. 32, 2547-59 (1997). A second example is the formation of metal oxide particles by polymer induced colloidal aggregation as described in M. J. Annen, R. Kizhappali, P. W. Carr, and A. McCormick, “Development of Porous Zirconia Spheres by Polymerization-Induced Colloid Aggregation-Effect of Polymerization Rate,” J. Mater. Sci. 29, 6123-30 (1994). A polymer induced colloidal aggregation technique is also described in U.S. Pat. No. 5,540,834, the contents of which are herein incorporated by reference.

Metal oxide catalysts used in embodiments of the invention can be sintered by heating them in a furnace or other heating device at a relatively high temperature. In some embodiments, the metal oxide is sintered at a temperature of about 160° C. or greater. In some embodiments, the metal oxide is sintered at a temperature of about 400° C. or greater. In some embodiments, the metal oxide is sintered at a temperature of about 600° C. or greater. Sintering can be done for various amounts of time depending on the desired effect. Sintering can make metal oxide catalysts more durable. In some embodiments, the metal oxide is sintered for more than about 30 minutes. In some embodiments, the metal oxide is sintered for more than about 3 hours. However, sintering also reduces the surface area. In some embodiments, the metal oxide is sintered for less than about 1 week.

In some embodiments, the metal oxide catalyst is in the form of particles. Particles within a desired size range can be specifically selected for use as a catalyst. For example, particles can be sorted by size using techniques such as air classification, elutriation, settling fractionation, or mechanical screening. In some embodiments, the size of the particles is greater than about 0.2 μm. In some embodiments, the size range selected is from about 0.2 μm to about 10 mm. In some embodiments, the size range selected is from about 0.2 μm to about 5 mm. In some embodiments, the size range selected is from about 0.2 μm to about 1 mm. In some embodiments, the size range selected is from about 1 μm to about 100 μm. In some embodiments, the size range selected is from about 5 μm to about 15 μm. In some embodiments, the average size selected is about 10 μm. In some embodiments, the average size selected is about 5 μm.

In some embodiments, metal oxide particles used with embodiments of the invention are porous. By way of example, in some embodiments the metal oxide particles can have an average pore size of about 30 angstroms to about 2000 angstroms. However, in other embodiments, metal oxide particles used are non-porous.

The physical properties of a porous metal oxide can be quantitatively described in various ways such as by surface area, pore volume, porosity, and pore diameter. In some embodiments, metal oxide catalysts of the invention can have a surface area of between about 1 and about 400 m²/gram. In some embodiments, metal oxide catalysts of the invention can have a surface area of between about 1 and about 200 m²/gram. Pore volume refers to the proportion of the total volume taken up by pores in a material per weight amount of the material. In some embodiments, metal oxide catalysts of the invention can have a pore volume of between about 0.01 mL/g and about 2 mL/g. Porosity refers to the proportion within a total volume that is taken up by pores. As such, if the total volume of a particle is 1 cm³ and it has a porosity of 0.5, then the volume taken up by pores within the total volume is 0.5 cm³. In some embodiments, metal oxide catalysts of the invention can have a porosity of between about 0 and about 0.8. In some embodiments, metal oxide catalysts of the invention can have a porosity of between about 0.3 and 0.6.

Metal oxide particles used with embodiments of the invention can have various shapes. By way of example, in some embodiments the metal oxide can be in the form of spherules. In other embodiments, the metal oxide can be a monolith. In some embodiments, the metal oxide can have an irregular shape.

The Lewis acid sites on metal oxides of the invention can interact with Lewis basic compounds. Thus, in some embodiments, Lewis basic compounds can be bonded to the surface of metal oxides. However, in other embodiments, the metal oxides used with embodiments herein are unmodified and have no Lewis basic compounds bonded thereto. A Lewis base is an electron pair donor. Lewis basic compounds of the invention can include anions formed from the dissociation of acids such as hydrobromic acid, hydrochloric acid, hydroiodic acid, nitric acid, sulfuric acid, perchloric acid, boric acid, chloric acid, phosphoric acid, pyrophosphoric acid, chromic acid, permanganic acid, phytic acid and ethylenediamine tetramethyl phosphonic acid (EDTPA), and the like. Lewis basic compounds of the invention can also include hydroxide ion as formed from the dissociation of bases such as sodium hydroxide, potassium hydroxide, lithium hydroxide and the like.

The anion of an acid can be bonded to a metal oxide of the invention by refluxing the metal oxide in an acid solution. By way of example, metal oxide particles can be refluxed in a solution of sulfuric acid. Alternatively, the anion formed from dissociation of a base, such as the hydroxide ion formed from dissociation of sodium hydroxide, can be bonded to a metal oxide by refluxing in a base solution. By way of example, metal oxide particles can be refluxed in a solution of sodium hydroxide. The base or acid modification can be achieved under exposure to the acid or base in either batch or continuous flow conditions when disposed in a reactor housing at elevated temperature and pressure to speed up the adsorption/modification process. In some embodiments, fluoride ion, such as formed by the dissociation of sodium fluoride, can be bonded to the particles.

In some embodiments, metal oxide particles can be packed into a housing, such as a column. Disposing metal oxide particles in a housing is one approach to facilitating continuous flow processes. Many different techniques may be used for packing the metal oxide particles into a housing. The specific technique used may depend on factors such as the average particle size, the type of housing used, etc. Generally speaking, particles with an average size of about 1-20 microns can be packed under pressure and particles with an average size larger than 20 microns can be packed by dry-packing/tapping methods or by low pressure slurry packing In some embodiments, the metal oxide particles of the invention can be impregnated into a membrane, such as a PTFE membrane.

However, in some embodiments, metal oxide catalysts used with embodiments of the invention are not in particulate form. For example, a layer of a metal oxide can be disposed on a substrate in order to form a catalyst used with embodiments of the invention. The substrate can be a surface that is configured to contact the feedstocks during processing. In one approach, a metal oxide catalyst can be disposed as a layer over a surface of a reactor that contacts the feedstocks. Alternatively, the metal oxide catalyst can be embedded as a particulate in the surface of an element that is configured to contact the feedstocks during processing.

Hydrolysis of lipids with water using a metal oxide catalyst is temperature dependent. If the temperature is not high enough, the reaction will not proceed optimally. If the temperature is too high, the desired product may not be created or may be consumed in a further reaction. As such, in some embodiments, the reaction is carried out at about 150° Celsius or hotter. In some embodiments, the reaction is carried out at about 200° Celsius or higher. In some embodiments, the reaction is carried out at about 300° Celsius or higher. In some embodiments, the reaction is carried out at about 150° Celsius and about 400° Celsius. In some embodiments, the reaction is carried out at about 280° Celsius and about 320° Celsius. In some embodiments, the temperature is greater than the critical temperature for water.

Esterification and etherification of fatty acids with alcohols, including diols, using a metal oxide catalyst is temperature dependent. In some embodiments, the esterification or etherification reaction is carried out at about 150° Celsius or hotter. In some embodiments, the reaction is carried out at about 200° Celsius or higher. In some embodiments, the reaction is carried out at about 300° Celsius or higher. In some embodiments, the reaction is carried out at about 150° Celsius and about 400° Celsius. In some embodiments, the reaction is carried out at about 280° Celsius and about 320° Celsius. In some embodiments, the temperature is greater than the critical temperature for the alcohol used.

In an embodiment, the pressure during the reaction is greater than the vapor pressures of any of the components of the reaction mixture. In an embodiment, the pressure is greater than about 100 psi. In an embodiment, the pressure is greater than about 500 psi. In an embodiment, the pressure is greater than about 800 psi. In an embodiment, the pressure is greater than about 1000 psi. In an embodiment, the pressure is greater than about 1500 psi. In an embodiment, the pressure is greater than about 2000 psi. In an embodiment, the pressure is greater than about 3000 psi. In an embodiment, the pressure is greater than about 3000 psi. In an embodiment, the pressure is greater than about 4000 psi. In some embodiments, the pressure is between about 1500 psi and about 5000 psi. In some embodiments, the pressure during the reaction is greater than the critical pressure of water. In some embodiments, the pressure during the reaction is greater than the critical pressure of the alcohol used.

In an embodiment, the contact time is between about 0.1 seconds and 2 hours. In an embodiment, the contact time is between about 1 second and 20 minutes. In an embodiment, the contact time is between about 2 seconds and 1 minute.

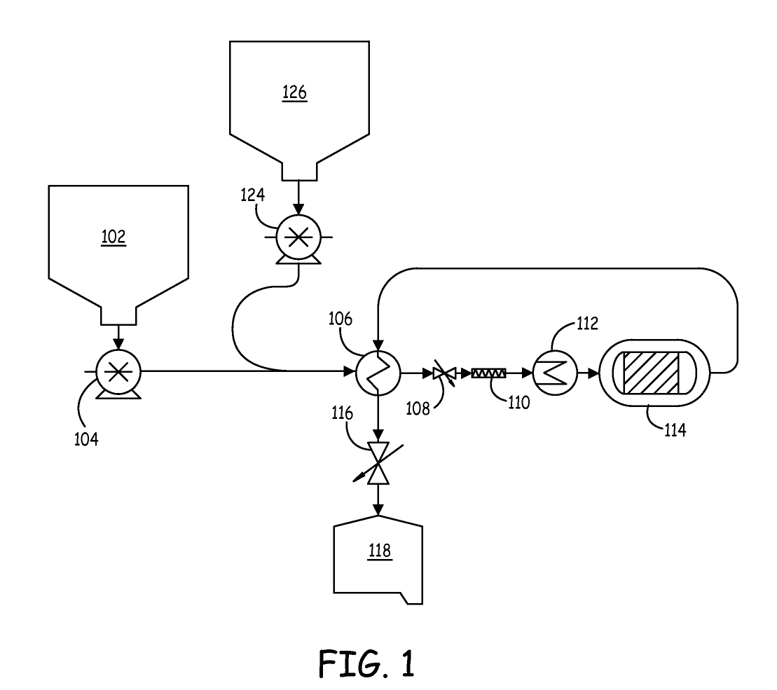

Referring now to FIG. 1, a schematic view of a basic reactor setup is presented in accordance with an embodiment of the invention. In this embodiment, a feedstock, such as a lipid feedstock is held in a first feedstock tank 102. Various examples of lipid feedstocks are described in greater detail below. However, it will be appreciated that the scope of lipid feedstocks contemplated for use herein is quite broad and therefore the listing is being provided only by way of non-limiting example. A co-reactant, such as water, is held in a second feedstock tank 126. One or both of the feedstock tanks can be continuously sparged with an inert gas such as nitrogen to remove dissolved oxygen from the respective feedstock. While this embodiment of a reactor setup includes two separate feedstock tanks, it will be appreciated that in some embodiments only a single feedstock tank can be used and the reactants can be combined together within the single feedstock tank.

The feedstocks then pass from the first feedstock tank 102 and second feedstock tank 126 through pumps 104 and 124, respectively, before being combined and passing through a heat exchanger 106 where the feedstocks absorb heat from downstream products. The mixture then passes through a shutoff valve 108 and, optionally, a filter 110. The feedstock mixture then passes through a preheater 112 and through a reactor 114 where the feedstock mixture is converted into a product mixture. The reactor can include a metal oxide catalyst, such as in the various forms described herein. In some embodiments, the metal oxide catalyst is in the form of a particulate and it is packed within the reactor.

The reaction product mixture can pass through the heat exchanger 106 in order to transfer heat from the effluent reaction product stream to the feedstock streams. The liquid reaction product mixture can also pass through a backpressure regulator 116 before passing on to a liquid reaction product storage tank 118. Various other processes can be performed on the product mixture. By way of example, a lipid phase can be separated from a phase that includes a product mixture. In some embodiments, various products can be separated from one another using distillation techniques. In some embodiments, the reaction products can be isolated from one another and then subjected to further reaction steps such as those described in the examples herein.

### Lipid Feed Stocks

Lipid feed stocks used in embodiments of the invention can be derived from many different sources. In some embodiments, lipid feed stocks used in embodiments of the invention can include biological lipid feed stocks. Biological lipid feed stocks can include lipids (fats or oils) produced by any type of microorganism, plant or animal. In an embodiment, the biological lipid feed stocks used includes triglycerides.

Exemplary lipid feed stocks can specifically include babassu, coconut oil, palm oil, palm kernel oil, and cocoa butter, amongst others. Further plant-based lipid feed stocks can include rapeseed oil, soybean oil (including degummed soybean oil), canola oil, cottonseed oil, grape seed oil, mustard seed oil, corn oil, linseed oil, safflower oil, sunflower oil, poppy-seed oil, pecan oil, walnut oil, oat oil, peanut oil, rice bran oil, camellia oil, castor oil, and olive oil, rice oil, algae oil, seaweed oil, Chinese Tallow tree oil. Other plant-based biological lipid feed stocks can be obtained from argan, avocado, balanites, borneo tallow nut, brazil nut, calendula, camelina, caryocar, cashew nut, chinese vegetable tallow, coffee, cohune palm, coriander, cucurbitaceae, euphorbia, hemp, illipe, jatropha, jojoba, kenaf, kusum, macadamia nuts, mango seed, noog abyssinia, nutmeg, opium poppy, perilla, pili nut, pumpkin seed, rice bran, sacha inche, seje, sesame, shea nut, teased, allanblackia, almond, chaulmoogra, cuphea, jatropa curgas, karanja seed, neem, papaya, tonka bean, tung, and ucuuba, cajuput, clausena anisata, davana, galbanum natural oleoresin, german chamomile, hexastylis, high-geraniol monarda, juniapa-hinojo sabalero, lupine, melissa officinalis, milfoil, ninde, patchouli, tarragon, and wormwood.

In some embodiments lipid feed stocks derived from microorganisms (Eukaryotes, Eubacteria and Archaea) can also be used. By way of example, microbe-based lipid feed stocks can include the L-glycerol lipids of Archaea and algae and diatom oils.

In some embodiments, specific fatty acids may be directly utilized in embodiments herein. Fatty acids can include short-chain fatty acids, medium-chain fatty acids, long-chain fatty acids, and very-long chain fatty acids. Fatty acids can include saturated, monounsaturated, and polyunsaturated. Fatty acids can include, but are not limited to, saturated fatty acids such as lauric acid, myrisitic acid, palmitic acid, stearic acid, arachidic acid, behenic acid, lignoceric acid, cerotic acid; unsaturated fatty acids such as myristoleic acid, palmitoleic acid, sapienic acid, oleic acid, elaidic acid, vaccenic acid, linoleic acid, linoelaidic acid, alpha-linolenic acid, arachidonic acid, eicosapentaenoic acid, erucic acid, docosahexaenoic acid, and the like.

It will be appreciated that compounds produced in accordance with embodiments herein have various uses including, but not limited to, surfactants, detergents, wetting agents, emulsifiers, foaming agents, and dispersants. Compounds herein can be applied in various compositions such as in pharmaceutical compositions, cosmetics compositions, food compositions, general industrial compositions, and printing compositions, amongst others.

The present invention may be better understood with reference to the following examples. These examples are intended to be representative of specific embodiments of the invention, and are not intended as limiting the scope of the invention.

### EXAMPLES

### Example 1

### Formation of a Reactor

Titania catalyst (80 micron average diameter, 60 angstrom average pore size) was dry-packed into two of 25 cm×10.0 mm i.d. stainless steel reactor tubes. Each tube contained approximately 27.1 g of titania.

### Example 2

### Hydrolysis of Babassu Oil

The hydrolysis of babassu oil was performed using the previously described process by reacting the oil directly with water over a titanium dioxide catalyst. This reaction produced a biphasic product stream with a top layer consisting of fatty acids and partially reacted glycerides and a bottom layer composed of glycerol and water. The reaction was as follows:

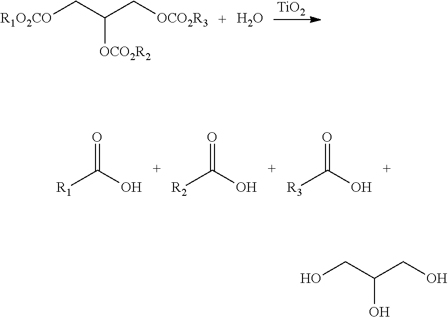

This reaction was studied in detail. The efficacy of the reaction was measured by acid titration of the upper layer. The value is presented as an acid number. The acid number is the mass of potassium hydroxide (KOH) in milligrams that is required to neutralize one gram of the chemical substance being assessed. Theoretically, an acid number of 200 would represent complete conversion. Acid numbers higher than 200 may be attributed to the decomposition of glycerol to acidic products. Tables 1-3 show the effects of temperature, catalyst contact time and molar ratio on the hydrolysis. Table 4 shows the results of the hydrolysis of babassu oil when no catalyst was present (blank experiment). Note that while the data presented is for the hydrolysis of babassu oil with water over titanium dioxide, but this reaction is not limited to this particular lipid feedstock oil or this particular metal oxide catalyst.

TABLE 1
The effect of temperature on the hydrolysis of babassu
oil with water over titanium dioxide using a 20:1 water:oil
molar ratio and a 120 s catalyst contact time.

| | Molar | | Contact | Back | | |
|---|---|---|---|---|---|---|
| | Ratio | Temp | time | Pressure | | Acid |
| Sample | (H2O:Oil) | (° C.) | (sec) | (psi) | Catalyst | Number |
| ST33-19B | 20:1 | 300 | 120 | 1600 | TiO₂ | 65 |
| ST33-19C | 20:1 | 310 | 120 | 1600 | TiO₂ | 97 |
| ST33-19D | 20:1 | 320 | 120 | 1600 | TiO₂ | 191 |
| ST33-19E | 20:1 | 330 | 120 | 1600 | TiO₂ | 212 |
| ST33-19F | 20:1 | 340 | 120 | 1600 | TiO₂ | 187 |
| ST33-19G | 20:1 | 350 | 120 | 1600 | TiO₂ | 185 |

TABLE 2
The effect of contact time on the hydrolysis of babassu
oil with water over titanium dioxide using a 40:1
water:oil molar ratio at 300 and 310° C.

| | Molar | | Contact | Back | | |
|---|---|---|---|---|---|---|
| | Ratio | Temp | time | Pressure | | Acid |
| Sample | (H2O:Oil) | (° C.) | (sec) | (psi) | Catalyst | Number |
| ST33-39Fr2 | 40:1 | 300 | 180 | 2000 | TiO₂ | 61 |
| ST33-39Fr12 | 40:1 | 310 | 180 | 2000 | TiO₂ | 149 |
| ST33-39Fr4 | 40:1 | 300 | 300 | 2000 | TiO₂ | 91 |
| ST33-39Fr10 | 40:1 | 310 | 300 | 2000 | TiO₂ | 206 |
| ST33-39Fr6 | 40:1 | 300 | 600 | 2000 | TiO₂ | 214 |
| ST33-39Fr8 | 40:1 | 310 | 600 | 2000 | TiO₂ | 220 |

TABLE 3
The effects of contact time and molar ratio on the hydrolysis
of babassu oil with water titanium dioxide using at 310° C.

| | Molar | | Contact | Back | | |
|---|---|---|---|---|---|---|
| | Ratio | Temp | time | Pressure | | Acid |
| Sample | (H2O:Oil) | (° C.) | (sec) | (psi) | Catalyst | Number |
| ST35-75Fr1 | 20:1 | 310 | 300 | 1500 | TiO₂ | 195 |
| ST35-75Fr2 | 20:1 | 310 | 300 | 1500 | TiO₂ | 194 |
| ST35-75Fr7 | 20:1 | 310 | 180 | 1500 | TiO₂ | 135 |
| ST35-75Fr8 | 20:1 | 310 | 180 | 1500 | TiO₂ | 136 |
| ST35-75Fr3 | 40:1 | 310 | 300 | 1500 | TiO₂ | 238 |
| ST35-75Fr4 | 40:1 | 310 | 300 | 1500 | TiO₂ | 245 |
| ST35-75Fr5 | 40:1 | 310 | 180 | 1500 | TiO₂ | 196 |
| ST35-75Fr6 | 40:1 | 310 | 180 | 1500 | TiO₂ | 195 |

TABLE 4
The effects of contact time and temperature on the hydrolysis
of babassu oil with water without a catalyst.

| | Molar | | Contact | Back | | |
|---|---|---|---|---|---|---|
| | Ratio | Temp | time | Pressure | | Acid |
| Sample | (H2O:Oil) | (° C.) | (sec) | (psi) | Catalyst | Number |
| ST33-23 A | 40:1 | 300 | 300 | 1500 | None | 66 |
| ST33-23 B | 40:1 | 300 | 180 | 1500 | None | 34 |
| ST33-23 C | 40:1 | 310 | 180 | 1500 | None | 63 |
| ST33-23 D | 40:1 | 320 | 120 | 1500 | None | 19 |
| ST33-23 E | 40:1 | 330 | 120 | 1500 | None | 19 |

### Example 3

### Synthesis of 3-dodecanoyl-1-propanol

The synthesis of 3-dodecanoyl-1-propanol was accomplished by using the continuous reactor setup described. The reaction was as follows:

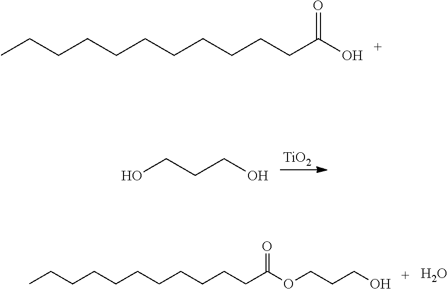

A solution of lauric acid in THF (1.5 M solution) was prepared and then mixed with the appropriate amount of 1,3-propanediol (PDO). Flow ratios, contact times and temperatures were investigated to maximize the yield of ester-alcohol product. An example set of reaction conditions are shown in Table 5. The conversion was measured by ¹H-NMR spectroscopy.

TABLE 5
The effect on temperature on the esteriflcation
of lauric acid with 1,3-propanediol.

| | Molar | | Contact | Back | | % Con- |
|---|---|---|---|---|---|---|
| | Ratio | Temp | time | Pressure | | version |
| Sample | (PDO:Oil) | (° C.) | (sec) | (psi) | Catalyst | (NMR) |
| ST33-08Fr1 | 15:1 | 280 | 120 | 1500 | TiO₂ | 53 |
| ST33-08Fr2 | 15:1 | 290 | 120 | 1500 | TiO₂ | 72 |
| ST33-08Fr3 | 15:1 | 300 | 120 | 1500 | TiO₂ | 76 |
| ST33-08Fr4 | 15:1 | 310 | 120 | 1500 | TiO₂ | 79 |
| ST33-08Fr5 | 15:1 | 320 | 120 | 1500 | TiO₂ | 69 |
| ST33-08Fr6 | 15:1 | 330 | 120 | 1500 | TiO₂ | 37 |

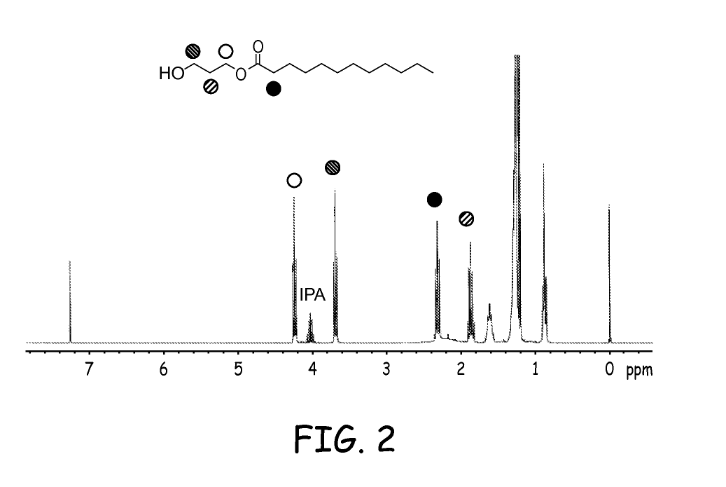

After collection, the single layer was transferred to a round bottom flask and the THF was removed by rotary evaporation. The mixture was then placed in a reparatory funnel and hexanes were added. This immediately caused two layers to form. The bottom layer, unreacted 1,3-PDO and water, were separated and extracted with a second portion of hexanes. The hexanes layers were combined and extracted 3 times with 1.5% aqueous NH₃ solution. Isopropyl alcohol was carefully added to each extraction to break up the emulsion and induce separation of the layers. The aqueous extract layers were combined and back extracted twice with hexanes. All the hexanes layers were combined and washed with water and saturated sodium chloride. The hexanes layer was then dried over a mixture of sodium sulfate and basic alumina to remove the last traces of acid. The ester-alcohol was then concentrated by rotary evaporation under high vacuum. A ¹H-NMR is shown in FIG. 2.

### Example 4

### Direct Reaction of Babassu Oil and 1,3-propanediol

The direct transesterification of basassu oil using 1,3-propanediol was investigated using the continuous reactor setup described. Both the babassu and 1,3-propanediol streams were heated to 70° C. prior to pumping. Flow ratios, contact times and temperatures were investigated to maximize the yield of ester-alcohol product. An example set of reaction conditions is shown in Table 6. The conversion was measured by ¹H-NMR spectroscopy.

TABLE 6
The direct transesterification of babassu
oil with 1,3-propanediol at 340° C.

| | Contact | Reactor | PDO:Oil | Back | |
|---|---|---|---|---|---|
| | Time | Temp | Molar | pressure | % Conv |
| Sample | (sec) | (° C.) | ratio | (psi) | (NMR) |
| ST33-17A | 45 | 340 | 15:1 | 1600 | 44% |
| ST33-17B | 45 | 340 | 30:1 | 1600 | 44% |
| ST33-17C | 45 | 340 | 50:1 | 1600 | 51% |
| ST33-17D | 60 | 340 | 15:1 | 1600 | 45% |
| ST33-17E | 60 | 340 | 30:1 | 1600 | 52% |
| ST33-17F | 60 | 340 | 50:1 | 1600 | 53% |

### Example 5

### Two-Step Reaction Production of Ester-Alcohol

The two-step production of the ester-alcohol is achieved by first reacting the babassu oil with water as described in Example 2 above. This hydrolysis of babassu oil produces a two-layer product. The top layer consists of fatty acids and partially reacted glycerides. The bottom layer consists of a water-glycerol mixture. After collection the two layers are separated using a reparatory funnel. The fatty acid layer is then directly used in the next step or subjected to a vacuum distillation to produce a pure fatty acid stream.

The fatty acid stream, crude or distilled, is directly reacted with 1,3-PDO using the same system described. Both incoming streams are preheated. The resulting product stream is then purified as previously described for 3-dodecanoyl-1-propanol.

### Example 6

### Synthesis of Sodium 3-Dodecanoyl-1-Propanesulfate

The sulfate is produced from 3-dodecanoyl-1-propanol by direct sulfonation with chlorosulfonic acid as follows:

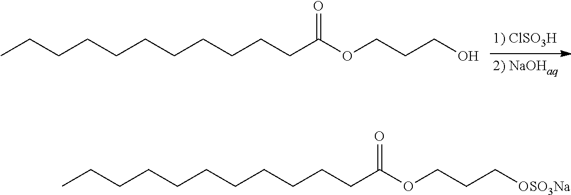

A slight molar excess (1.05 eq) of chlorosulfonic acid is added slowly with cooling and mixing to the -dodecanoyl-1-propanol. Once the addition of chlorosulfonic acid is complete, the acid-ester mixture is slowly poured into water containing a slight molar excess (1.10 eq) of sodium hydroxide to neutralize the acid-ester. Neutralizing the acid ester with sodium hydroxide results in the final product, a solution of sodium 3-dodecanoyl-1-propanesulfate.

### Example 7

### Synthesis of Lauryl Propanediol Sulfosuccinate

The sulfosuccinate of 3-dodecanoyl-1-propanol was prepared according to the following reaction diagram:

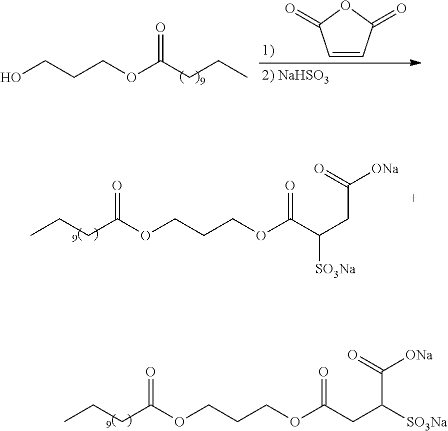

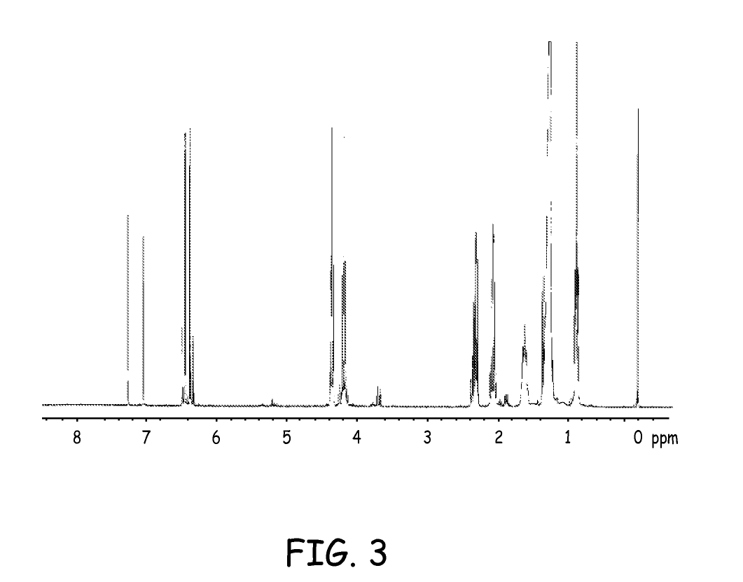

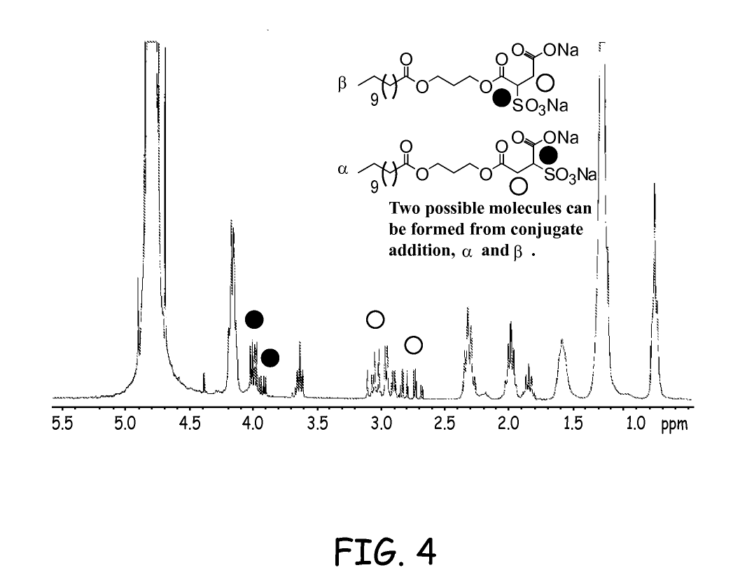

Specifically, 3-dodecanoyl-1-propanol was directly reacted with a slight molar excess (1.05 eq) of maleic anhydride at 70° C. The crude product NMR is shown in FIG. 3. The reaction was then added slowly to a prepared 1:1 solution of NaHSO₃:NaOH with careful monitoring of the pH. The pH of the solution was maintained between 5 and 7 using 30% NaOH. The targeted sulfosuccinate concentration was 30%. After 3 hrs the reaction was assumed to be complete and the pH was adjusted to 6.5. The properties of the surfactant were then investigated. A ¹H-NMR of the solution is shown in FIG. 4.

### Example 8

### Babassu Propanediol Sulfosuccinate

The sulfosuccinate of babassu esters derived from the reaction of babassu fatty acids with propanediol was prepared according to the same basic procedure followed in Example 7. Babassu propanediol was directly reacted with a slight molar excess (1.05 eq) of maleic anhydride at 70° C. The reaction was then added slowly to a prepared 1:1 solution of NaHSO₃:NaOH with careful monitoring of the pH. The pH of the solution was maintained between 5 and 7 using 30% NaOH. The targeted sulfosuccinate concentration was 30%. After 3 hrs the reaction was assumed to be complete and the pH was adjusted to 6.5. The properties of the surfactant were then investigated.

### Example 9

### Cuphea Oil Free Fatty Acids with Propylene Glycol

The esterification of free fatty acids (FFAs) derived from the hydrolysis of cuphea oil using the aforementioned hydrolysis process (e.g., Example 2) was performed using the reactor described and propylene glycol as the diol source. The reactants were premixed in a 10:1 (m/m) ratio, corresponding to a 30:1 molar ratio of propylene glycol to cuphea FFAs. The mixture was heated to 65° C. A single pump was used to deliver the mixture to the reactor. This reaction was conducted at 300° C., 1500 psi and a 3 minute alumina catalyst contact time.

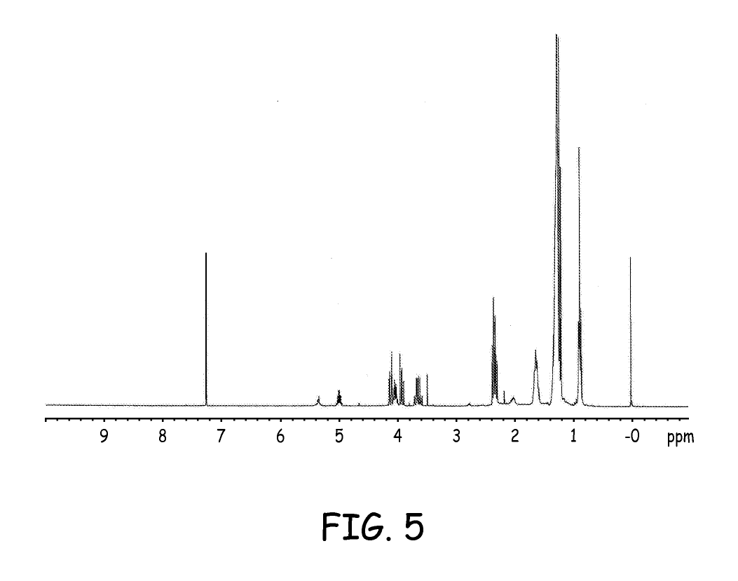

After reaction the crude product was isolated by transferring to a separatory funnel and conducting multiple water washes. The crude product mixture was analyzed by ¹H-NMR spectroscopy (FIG. 5). The conversion was found to be 93% based on the formation of the two possible product isomers, internal ester versus terminal ester. The ratio of isomers was determined to be 1.5:1 with the terminal ester formed as the major product.

### Example 10

### Cuphea Oil Free Fatty Acids with Ethylene Glycol

The esterification of free fatty acids (FFAs) derived from the hydrolysis of cuphea oil using the aforementioned hydrolysis process (e.g., Example 2) was performed using the reactor described and ethylene glycol as the diol source. The reactants were premixed in a 8:1 (m/m) ratio, corresponding to a 30:1 molar ratio of propylene glycol to cuphea FFAs. The mixture was heated to 65° C. A single pump was used to deliver the mixture to the reactor. This reaction was conducted at 290° C., 1500 psi and a 3 minute alumina catalyst contact time.

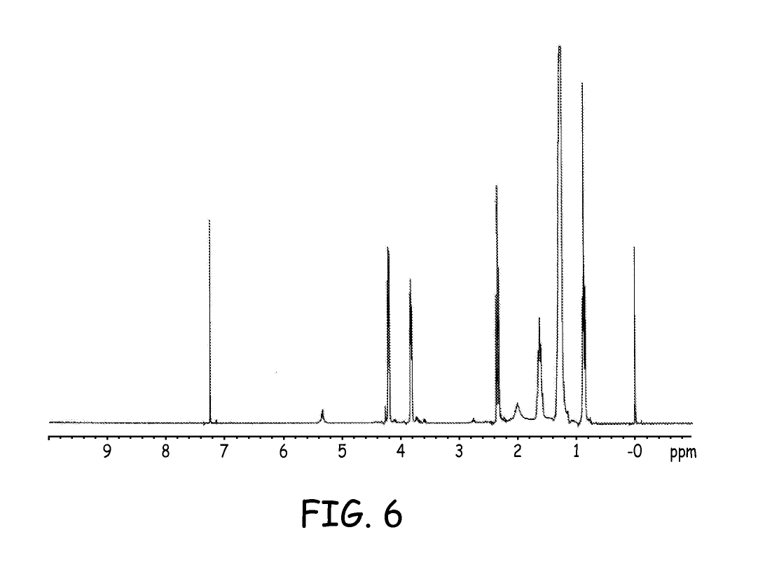

After reaction the crude product was isolated by transferring to a separatory funnel and conducting multiple water washes. The crude product mixture was analyzed by ¹H-NMR spectroscopy (FIG. 6). The conversion was found to be 85% based on formation of the monoester.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

1. A method of processing a lipid feedstock comprising:
combining triglycerides from the lipid feedstock with water to form a first reaction mixture;
contacting the first reaction mixture with a first metal oxide catalyst at a temperature of greater than 200 degrees Celsius to form a first product mixture including free fatty acids and glycerin;
combining the free fatty acids with a diol to form a second reaction mixture; and
contacting the second reaction mixture with a second metal oxide catalyst at a temperature of greater than 200 degrees Celsius to form a second product mixture.

2. The method of claim 1, wherein the second product mixture comprises an ester with a terminal alcohol group.

3. The method of claim 1, wherein the second product mixture comprises an ester of the formula: 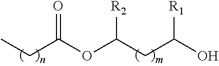
wherein R1 and R2 are independently H or CH3; m is 0-10; n is 4-22.

4. The method of claim 1, wherein the second product mixture comprises an ether with a terminal alcohol group.

5. The method of claim 1, wherein the second product mixture comprises an ether of the formula: 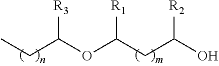
wherein R1, R2, and R3 are independently H or CH3, m is 0-10, n is 4-22.

6. The method of claim 2, further comprising sulfating the ester with the terminal alcohol group.

7. The method of claim 6, wherein sulfating the ester with the terminal alcohol group comprising forming sodium lauryl propanediol ester sulfate.

8. The method of claim 2, further comprising reacting the ester with the terminal alcohol group to form a sulfo-succinate.

9. The method of claim 8, wherein reacting the ester with the terminal alcohol group to form a sulfo-succinate comprises forming disodium propanediol lauryl sulfosuccinate.

10. The method of claim 1, wherein at least one of the first and second metal oxide catalyst selected from the group is consisting of zirconia, alumina, titania, and hafnia.

11-16. (canceled)

17. A method of making a compound of the formula: 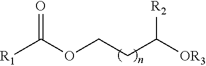
wherein R₁ is CH₃(CH₂)ₘ and may be interrupted with at least one heteroatom selected from the group consisting of amine, ether, ester, amide, sulfur, sulfur monoxide, sulfer dioxide, sulfamate, hydroxy, or mixtures thereof;
m=6-16;
n=0 or 1;
R₂═H or CH₃; and
R₃ ═H, SO₃X, CO(CH)₂COOH, or COCH(SO₃X)CH₂COOX₁; wherein X and Xᵢ are the same or different, and each is selected from NH₄⁺, an alkali metal, an H atom; hydrolyzing triglycerides using a first metal oxide catalyst to form a mixture including free fatty acids;
esterifying the free fatty acids with a compound having at least two alcohol groups using a second metal oxide catalyst to form an ester having a terminal alcohol group; and
reacting the ester to form a sulfate or a sulfo-succinate.

18. The method of claim 17, wherein the ester having a terminal alcohol group is 1,3-propanediol monolaurate.

19. The method of claim 17 wherein at least one of the first and second metal oxide catalyst is selected from the group consisting of zirconia, alumina, titania, and hafnia.

20. (canceled)

21. The method of claim 17, wherein hydrolyzing triglycerides is performed at a temperature of greater than 250 degrees Celsius.

22. (canceled)

23. The method of claim 17, wherein esterifying the free fatty acids is performed at a temperature of greater than 250 degrees Celsius.

24. (canceled)

25. A method of making a surfactant comprising:
combining triglycerides from the lipid feedstock with water to form a first reaction mixture;
contacting the first reaction mixture with a first metal oxide catalyst at a temperature of greater than 200 degrees Celsius to form a first product mixture including free fatty acids and glycerin;
combining the free fatty acids with a diol to form a second reaction mixture;
contacting the second reaction mixture with a second metal oxide catalyst at a temperature of greater than 200 degrees Celsius to form a second product mixture; and
reacting a constituent of the second product mixture to form a sulfate or a sulfo-succinate compound.

26. The method of claim 25, wherein the second product mixture comprises an ester with a terminal alcohol group.

27. The method of claim 25, wherein the second product mixture comprises an ester of the formula: 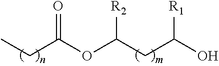
wherein R1 and R2 are independently H or CH3; m is 0-10; n is 4-22.

28. The method of claim 25, wherein the second product mixture comprises an ether with a terminal alcohol group.

29. The method of claim 25, wherein the second product mixture comprises an ether of the formula: 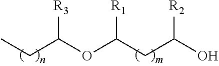
wherein R1, R2, and R3 are independently H or CH3, m is 0-10, n is 4-22.

30. The method of claim 26, further comprising sulfating the ester with the terminal alcohol group.

31. The method of claim 30, wherein sulfating the ester with the terminal alcohol group comprising forming sodium lauryl propanediol ester sulfate.

32. he method of claim 26, further comprising reacting the ester with the terminal alcohol group to form a sulfo-succinate.

33. The method of claim 32, wherein reacting the ester with the terminal alcohol group to form a sulfo-succinate comprises forming disodium propanediol lauryl sulfosuccinate.

34. The method of claim 25, wherein at least one of the first and second metal oxide catalyst is selected from the group consisting of zirconia, alumina, titania, and hafnia.

35-39. (canceled)
